(19) United States
(12) Patent Application Publication
(10) Pub. No.: US 2014/0354050 A1
(43) Pub. Date: Dec. 4, 2014

(54) POWER BANK AND CONTROL METHOD FOR SUPPLYING POWER

(71) Applicants: Nien-Hui Kung, Hsinchu (TW); Hsuan-Kai Wang, Taoyuan (TW)

(72) Inventors: Nien-Hui Kung, Hsinchu (TW); Hsuan-Kai Wang, Taoyuan (TW)

(73) Assignee: RICHTEK TECHNOLOGY CORPORATION, Chupei City (TW)

(21) Appl. No.: 13/907,359

(22) Filed: May 31, 2013

(51) Int. Cl. H02J 7/00

(52) U.S. Cl. CPC H02J 7/0068
USPC 307/24

(57) ABSTRACT

The present invention discloses a power bank and a control method for supplying power. The power bank includes a rechargeable battery, a charging switch for controlling a charging path to the rechargeable battery, a discharging switch for controlling a discharging path from the rechargeable battery, and a control circuit for controlling the charging switch and the discharging switch according to current information of the charging path, current information of the discharging path, and battery capacity information of the rechargeable battery. The power bank is adapted for being connected in series between a power supply apparatus and a load. The control method detects the supply current from the power supply apparatus and the current required by the load to determine the charging and discharging operations of the power bank.

### BACKGROUND OF THE INVENTION

1. Field of Invention

The present invention relates to a control method for supplying power and a power bank; particularly, it relates to such control method for supplying power wherein the method is capable of conducting charging operation from a power supply terminal to a power bank and conducting charging operation from the power bank to a load even though the supply current from the power supply terminal through the power supply apparatus is insufficient, and also relates to such power bank which can implement this control method.

2. Description of Related Art

Referring to the prior art shown in FIG. 1, when a portable electronic device (such as the load 12 shown in FIG. 1) requires to be charged, the power is usually supplied from a power supply terminal through a power supply apparatus 11 (e.g., an adaptor) or an external power bank 13 (e.g., through connection with USB). Because only one of the two charging paths can be chosen, the charging paths are illustrated by dashed lines in FIG. 1. When the power bank 13 requires to be charged, it usually receives power from the power supply terminal through an adaptor. If both the power bank 13 and the load 12 run out of power, in this prior art, a user can not connect the power supply apparatus 11 with the power bank 13 and then connect the power bank 13 with the load 12 (i.e., to form a series connection of power supply apparatus 11—power bank 13—load 12); this configuration does not work. The reason for such configuration not to be workable is because both the power bank 13 and the load 12 require to be charged, and the total current required by the power bank 13 and the load 12 is greater than the supply current from the power supply apparatus 11 (e.g., an adaptor). Under such circumstance, the adaptor will be unable to function; it will shut down or initiate other over current protection mechanism. In another case, when the adaptor is too old or has poor quality, even though the total current required by the power bank 13 and the load 12 is not much, as long as such total required current exceeds the power supply capacity of the adaptor, the adaptor will also shut down.

In view of the above, to overcome the drawbacks in the prior art, the present invention proposes a control method for supplying power. When both the power bank and the load run out of power, such control method for supplying power is capable of fulfilling the charging requirements of the power bank and the load, by coupling the power supply apparatus with the power bank and coupling the power bank with the load (i.e., to form a series connection of power supply apparatus—power bank—load. The present invention also proposes a power bank which is capable of implementing this control method.

### SUMMARY OF THE INVENTION

A first objective of the present invention is to provide a control method for supplying power.

A second objective of the present invention is to provide a power bank.

To achieve the above and other objectives, from one perspective, the present invention provides a control method for supplying power to a power bank through a power supply apparatus and supplying power to a load from the power bank, wherein the power supply apparatus, the power bank and the load are connected in series; the control method for supplying power comprising the steps of: (a) detecting a supply current from the power supply apparatus and a current required by the load; (b) determining whether the supply current is lower than the current required by the load; (c) when it is determined that the supply current is higher than the current required by the load, supplying power to the load from the power bank and charging a rechargeable battery of the power bank with a remaining current obtained by subtracting the current required by the load from the supply current; and (d) when it is determined yes, namely when the supply current is lower than the current required by the load, further determining whether a battery capacity of the rechargeable battery is higher than a first predetermined value; wherein: (d1) when the battery capacity of the rechargeable battery is higher than the first predetermined value, conducting a discharging operation from the rechargeable battery to the load to supply the current required by the load; and (d2) when the battery capacity of the rechargeable battery is lower than the first predetermined value, ceasing the discharging operation from the rechargeable battery to the load and conducting a charging operation from the power supply apparatus to the rechargeable battery.

The above-mentioned control method for supplying power may further comprise: (d3) after a predetermined period of time subsequent to the step (d2) of ceasing the discharging operation from the rechargeable battery to the load, determining whether a battery capacity of the rechargeable battery is higher than a second predetermined value; (d4) when the battery capacity of the rechargeable battery is higher than the second predetermined value, conducting a discharging operation from the rechargeable battery to the load to supply the current required by the load; and (d5) when the battery capacity of the rechargeable battery is lower than the second predetermined value, keeping conducting the charging operation from the power supply apparatus to the rechargeable battery.

In one embodiment, the second predetermined value is greater than the first predetermined value. The first predetermined value can be represented by a State of Charge (SOC) or a voltage level and the second predetermined value can be represented by a State of Charge (SOC) or a voltage level.

From another perspective, the present invention provides a power bank, comprising: a rechargeable battery; a charging switch for controlling a charging path to the rechargeable battery; a discharging switch for controlling a discharging path from the rechargeable battery; and a control circuit for controlling the charging switch and the discharging switch according to current information of the charging path, current information of the discharging path, and battery capacity information of the rechargeable battery.

In one embodiment, the charging path is coupled between the rechargeable battery and a power supply apparatus; the discharging path is coupled between the rechargeable battery and a load; and when a supply current from the power supply apparatus is higher than the current required by the load, the control circuit turns ON the charging switch and the discharging switch.

In one embodiment, the charging path is coupled between the rechargeable battery and a power supply apparatus; the discharging path is coupled between the rechargeable battery and a load; and when a supply current from the power supply apparatus is lower than the current required by the load and when a battery capacity of the rechargeable battery is higher than a first predetermined value, the control circuit turns ON the discharging switch.

In one embodiment, the charging path is coupled between the rechargeable battery and a power supply apparatus; the discharging path is coupled between the rechargeable battery and a load; and when a supply current from the power supply apparatus is lower than the current required by the load and when a battery capacity of the rechargeable battery is lower than a first predetermined value, the control circuit turns ON the charging switch and turns OFF the discharging switch.

Preferably, after a predetermined period of time subsequent to turning OFF the discharging switch by the control circuit, the control circuit turns ON the discharging switch when the battery capacity of the rechargeable battery is higher than a second predetermined value. When the battery capacity of the rechargeable battery is lower than a second predetermined value, the control circuit keeps turning ON the charging switch and keeps turning OFF the discharging switch.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional control method for supplying power.

FIG. 2 shows a block diagram, illustrating an embodiment of a hardware configuration where a control method according to the present invention can be applied to.

FIG. 3A shows a flowchart of an embodiment of the present invention, illustrating a control method for supplying power.

FIG. 3B shows a flowchart of another embodiment of the present invention, illustrating a control method for supplying power.

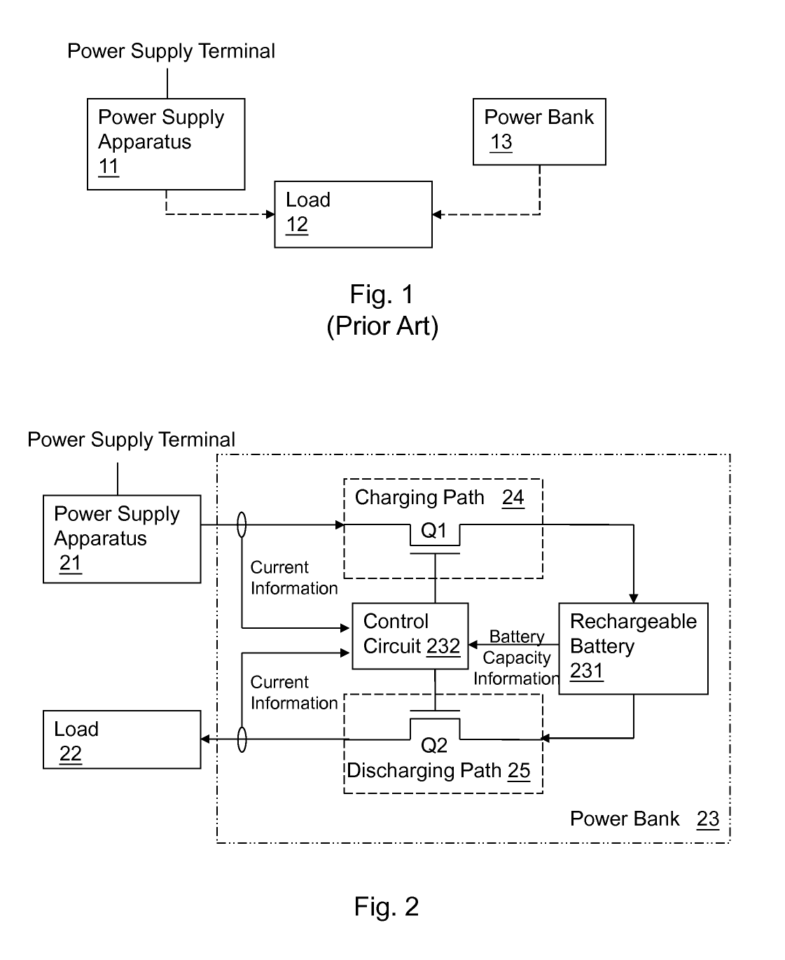

### DESCRIPTION OF THE PREFERRED EMBODIMENTS

The drawings as referred to throughout the description of the present invention are for illustration only, to show the interrelations between the apparatus and the devices, but not drawn according to actual scale.

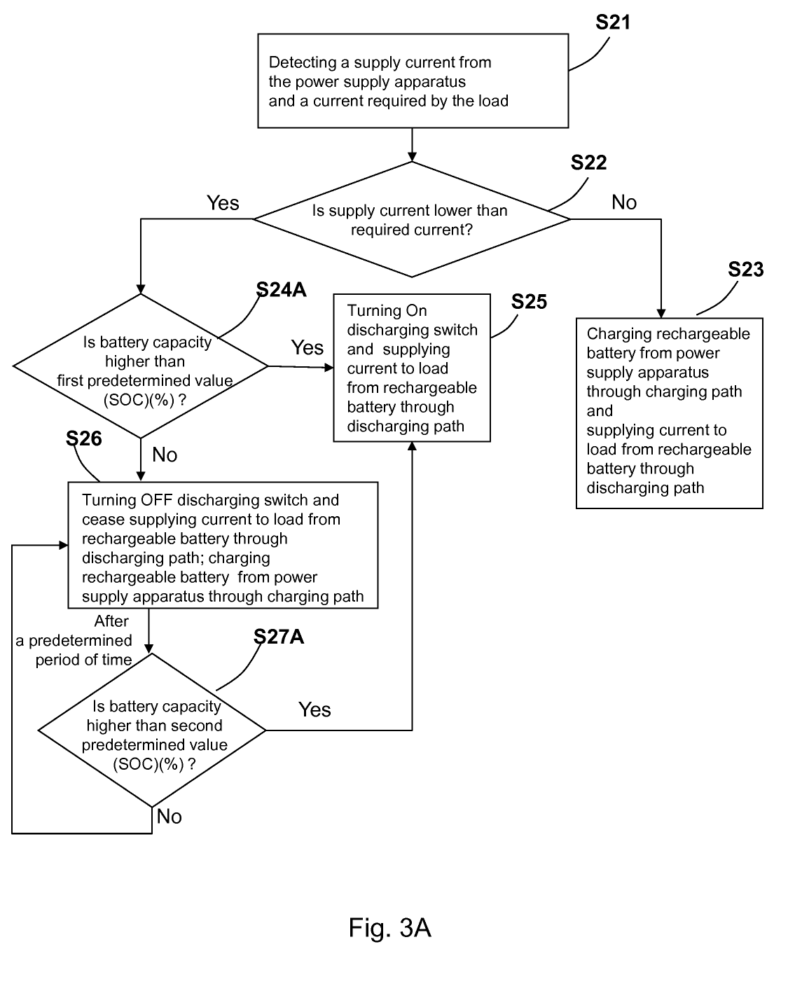

Please refer to FIG. 2. FIG. 2 shows a block diagram, illustrating an embodiment of a hardware configuration where a control method according to the present invention can be applied to. As shown in FIG. 2, the hardware configuration of the present invention comprises a power supply apparatus 21, a load 22 and a power bank 23. The load 22 can be for example but not limited to a portable electronic device (e.g., a mobile phone, a camera, and so on). The power supply apparatus 21 can be for example but not limited to an adaptor. The power bank 23 is connected in series between the power supply apparatus 21 and the load 22. The power bank 23 comprises a rechargeable battery 231, a control circuit 232, a charging switch Q1 and a discharging switch Q2. The control circuit 232 controls the charging switch Q1 and the discharging switch Q2 according to current information of a charging path 24, current information of a discharging path 25, and battery capacity information of the rechargeable battery 231 (the details will be discussed later). When the charging switch Q1 is turned ON, the power supply apparatus 21 charges the rechargeable battery 231 through the charging path 24. When the discharging switch Q2 is turned ON, the rechargeable battery 231 charges the load 22 through the discharging path 25. When the supply current of the power supply apparatus 21 is higher than the current required by the load 22, on one hand, the power supply apparatus 21 can effectively supply current to the load 22; on the other hand, the remaining power (the remaining current) is supplied to charge the rechargeable battery 231 of the power bank 23. When the supply current of the power supply apparatus 21 is lower than the current required by the load 22 and when the battery capacity of the rechargeable battery 231 is sufficient, the rechargeable battery 231 will supply current to the load 22 (the details will be discussed later).

The control circuit 232 (or part of it) and the charging switch Q1 can form a linear charger (e.g., a low drop-out voltage regulator) or a switching charger (e.g., a boost or buck switching regulator). The control circuit 232 (or part of it) and the discharging switch Q2 can also form a linear charger or a switching charger. The details of the linear charger and the switching charger are well known to those skilled in the art, which are therefore not redundantly explained here.

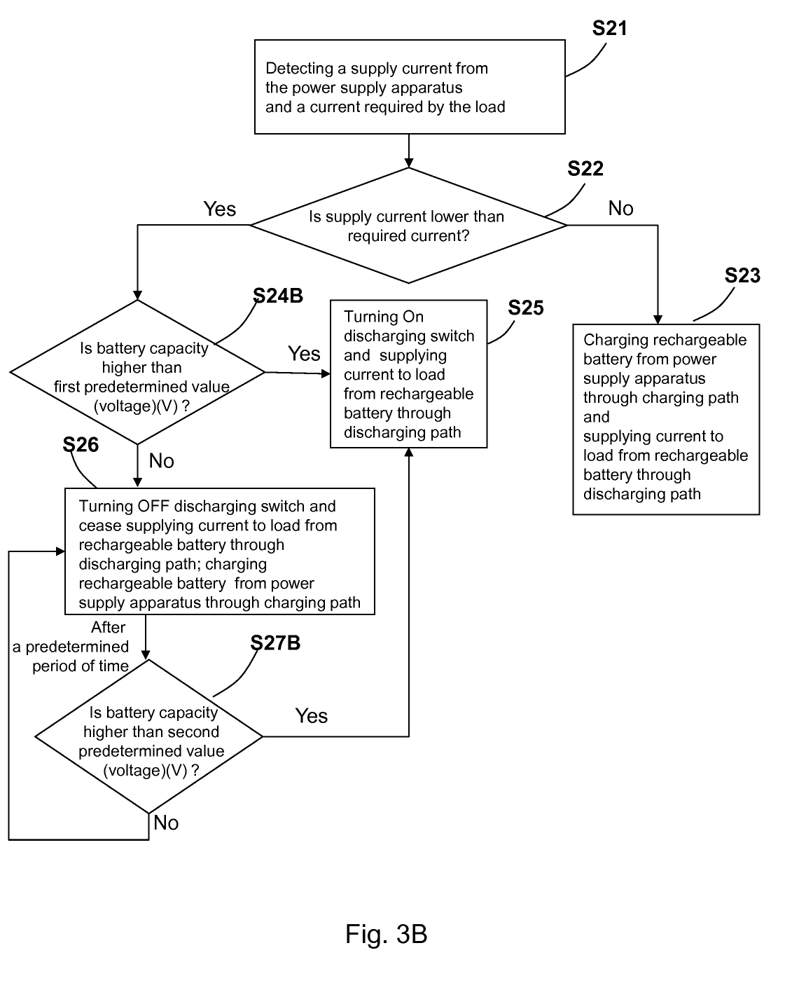

Next, please refer to FIGS. 3A and 3B, which illustrate a control method for supplying power according to the present invention. Note that The values of the voltage, current, or battery capacity described in the embodiments below are for illustrative purpose only, but not for limiting the scope of the present invention.

FIG. 3A shows a flowchart of an embodiment of the present invention, illustrating a control method for supplying power. Please refer to FIG. 2 in conjugation with FIG. 3A. First, in the step of S21, this embodiment detects a supply current from the power supply apparatus 21 and a current required by the load 22. Next, in the step of S22, this embodiment determines whether the supply current is lower than the current required by the load 22. For example, assuming that the load 22 is a mobile phone requiring a charging current of 0.5 A, and a power supply apparatus 21 (e.g., an adaptor) capable of supplying a maximum current of 1 A is used, then the supply current from the power supply apparatus 21 is higher than the current required by the load 22. Under such circumstance, the power supply apparatus 21 is able to supply the current required by the load 22 sufficiently (the judgment in the step of S22 is no). Notably, as shown in FIG. 2, the load 22 is coupled to the power supply apparatus 21 through the power bank 23. The power bank 23 also requires to be charged. According to the present invention, no matter what the original charging specification of the power bank 23 is, the configuration shown in FIG. 2 can operate smoothly.

More specifically, under the circumstance where the supply current from the power supply apparatus 21 is higher than the current required by the load 22, this embodiment turns ON not only the charging switch Q1 on the charging path 24 but also the discharging switch Q2 on the discharging path 25. Consequently, on one hand, the power supply apparatus 21 charges the rechargeable battery 231 of the power bank 23; on the other hand, the power bank 23 supplies power to the load 22 through the discharging path 25 (the step of S23). For example, assuming that the current required by the load 22 is 0.5 A and the maximum supply current from the power supply apparatus 21 is 1 A, the current requirement by the load 22 is fulfilled in a higher priority than the power bank 23, so the load 22 receives a full amount of current that it requires, i.e., 0.5 A. Therefore, since the total amount of current supplied from the power supply apparatus 21 through the charging path 24 is 1 A, and the charging current supplied to the load 22 through the discharging path 25 is 0.5 A, the charging current supplied to the rechargeable battery 231 of the power bank 23 is 0.5 A (1 A−0.5 A=0.5 A). When the current requirement by the load 22 changes (e.g., under certain charging mode, when the battery in the load 22 is near fully charged, the current requirement will be reduced), as long as the current requirement by the load 22 is fulfilled, the remaining current supplied from the power supply apparatus 21 can be supplied to the rechargeable battery 231. Certainly, if the sum of the current required by the load 22 plus the current required by the rechargeable battery 231 is lower than 1 A, then the power supply apparatus 21 does not need to supply a total current of 1 A.

For another example, assuming that the load 22 is a mobile phone requiring a charging current of 0.8 A, and a power supply apparatus 21 (e.g., an adaptor) capable of supplying a maximum current of 0.6 A is used, then the supply current from the power supply apparatus 21 is lower than the current required by the load 22 (the judgment in the step of S22 is yes). Under such circumstance, this embodiment further determines whether a battery capacity of the rechargeable battery 231 of the power bank 23 is higher than a first predetermined value (the step of S24A). The first predetermined value can be represented by a State of Charge (SOC) (%) or a voltage level (V). In this embodiment, the first predetermined value is represented by State of Charge (SOC). The battery capacity can be measured by various ways well known to those skilled in the art, which are therefore not redundantly repeated here. Assuming that the battery capacity of the rechargeable battery 231 has a SOC of 90% and the first predetermined value is 70%, under such circumstance, this embodiment determines that the battery capacity of the rechargeable battery 231 is higher than the first predetermined value. As a result, this embodiment will turn ON the discharging switch Q2 on the discharging path 25, thereby supplying the current required by the load 22 from the rechargeable battery 231 of the power bank 23 through the discharging path 25 (the step of S25). In this case, the charging switch Q1 can be turned ON or OFF. On the other hand, assuming that the battery capacity of the rechargeable battery 231 has a SOC of 50% and the first predetermined value is 70%, under such circumstance, this embodiment determines that the battery capacity of the rechargeable battery 231 is lower than the first predetermined value. As a result, this embodiment will turn OFF the discharging switch Q2 on the discharging path 25, thereby ceasing the discharging operation from the rechargeable battery 231 of the power bank 23 to the load 22 (the step of S26). In this case this embodiment can turn ON the charging switch Q1 on the charging path 24, so that the power supply apparatus 21 charges the rechargeable battery 231 of the power bank 23 through the charging path 24 (the step of S26).

After the rechargeable battery 231 is charged to a certain extent, this embodiment checks whether the battery capacity of the rechargeable battery 231 has reached a level sufficient to supply current to the load 22. That is, after a predetermined period of time subsequent to the step 26 of ceasing the discharging operation from the rechargeable battery 231 to the load 22, this embodiment checks whether the battery capacity of the rechargeable battery 231 is higher than a second predetermined value (the step of S27A). In this embodiment, the second predetermined value is greater than the first predetermined value. Certainly, in another embodiment, the second predetermined value and the first predetermined value can be the same. Assuming that the battery capacity of the rechargeable battery 231 has a SOC of 85% (rising up from 50% to 85% after being charged) and the second predetermined value is 80% (which is higher than 70% of the above-mentioned first predetermined value), under such circumstance, this embodiment determines that the battery capacity of the rechargeable battery 231 is higher than the second predetermined value. As a result, this embodiment will again turn ON the discharging switch Q2 on the discharging path 25, thereby supplying the current required by the load 22 from the rechargeable battery 231 of the power bank 23 through the discharging path 25 (the step of S25). In this case, the charging switch Q1 can be turned ON or OFF. On the other hand, assuming that the battery capacity of the rechargeable battery 231 has a SOC of 75% (rising up from 50% to 75% after being charged) and the second predetermined value is 80%, under such circumstance, this embodiment determines that the battery capacity of the rechargeable battery 231 is lower than the second predetermined value. As a result, this embodiment will keep turning OFF the discharging switch Q2 on the discharging path 25 while the power supply apparatus 21 keeps charging the rechargeable battery 231, until the battery capacity of the rechargeable battery 231 reaches a level sufficient to supply current to the load 22 (i.e., until the battery capacity of the rechargeable battery 231 is higher than the second predetermined value).

FIG. 3B shows a flowchart of another embodiment of the present invention, illustrating a control method for supplying power. Please refer to FIG. 3B. The control method for supplying power of this embodiment is substantially the same as the previous embodiment, but is different in that the battery capacity of this embodiment is represented by its voltage level (V), as shown by the steps of S24B and S27B in FIG. 3B. That is, the first predetermined value and the second predetermined value of this embodiment are represented by voltage (V). In the previous embodiment, the battery capacity is represented by State of Charge (SOC) (%), as shown by the steps of S24A and S27A in FIG. 3A. Except for the different approach for measuring the battery capacity, the control method for supplying power of this embodiment and the control method for supplying power of the previous embodiment have substantially the same features and advantages, which are not redundantly repeated here.

The technical features and advantages of the present invention are summarized as follow:

1. When the supply current of the power supply apparatus 21 is higher than the current required by the load 22, on one hand, the power supply apparatus 21 can effectively supply current to the load 22 (through the power bank 23); on the other hand, the remaining power (the remaining current) is supplied to the rechargeable battery 231 of the power bank 23. As a consequence, the supply current of the power supply apparatus 21 is more efficiently utilized.

2. When the supply current of the power supply apparatus 21 is lower than the current required by the load 22 and when the battery capacity of the rechargeable battery 231 is sufficient (when it is higher than the first predetermined value or the second predetermined value), the rechargeable battery 231 will supply current to the load 22. When the battery capacity of the rechargeable battery 231 is insufficient (when it is lower than the first predetermined value or the second predetermined value), the power supply apparatus 21 charges the rechargeable battery 231 of the power bank 23. In such manner, both the power bank 23 and the load 22 will be fully charged at the end, and the user does not need to charge the power bank 23 and the load 22 separately.

In light of the above, the present invention is apparently superior to the prior art in that: when the supply current of the power supply apparatus 21 is insufficient no mater due to the insufficient capability of the power supply apparatus 21 or the high current requirement by the sum of the current required by the load 22 plus the current required by the power bank 23, the present invention can effectively accomplish the charging operations to both the load 22 and power bank 23.

It should be noted that the present invention is not limited to the aforesaid sequence of the steps; while the steps are described in certain order with regard to FIGS. 3A and 3B, the sequence of the steps can be varied in other embodiments, and non-dependent steps can be implemented in parallel.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, in performing a comparison described in the above-mentioned embodiments, as one of average skill in the art will appreciate, the term. “higher than” or “lower than”, as may be used herein, may comprise “equal to” or may not comprise “equal to”. In view of the foregoing, the spirit of the present invention should cover all such and other modifications and variations, which should be interpreted to fall within the scope of the following claims and their equivalents.

What is claimed is:

1. A control method for supplying power to a power bank through a power supply apparatus and supplying power to a load from the power bank, wherein the power supply apparatus, the power bank and the load are connected in series; the control method for supplying power comprising the steps of:
(a) detecting a supply current from the power supply apparatus and a current required by the load;
(b) determining whether the supply current is lower than the current required by the load;
(c) when it is determined that the supply current is higher than the current required by the load, supplying power to the load from the power bank and charging a rechargeable battery of the power bank with a remaining current obtained by subtracting the current required by the load from the supply current; and
(d) when it is determined that the supply current is lower than the current required by the load, further determining whether a battery capacity of the rechargeable battery is higher than a first predetermined value; wherein:
(d1) when the battery capacity of the rechargeable battery is higher than the first predetermined value, conducting a discharging operation from the rechargeable battery to the load to supply the current required by the load; and
(d2) when the battery capacity of the rechargeable battery is lower than the first predetermined value, ceasing the discharging operation from the rechargeable battery to the load and conducting a charging operation from the power supply apparatus to the rechargeable battery.

2. The control method for supplying power of claim 1, further comprising:
(d3) after a predetermined period of time subsequent to the step (d2) of ceasing the discharging operation from the rechargeable battery to the load, determining whether a battery capacity of the rechargeable battery is higher than a second predetermined value;
(d4) when the battery capacity of the rechargeable battery is higher than the second predetermined value, conducting a discharging operation from the rechargeable battery to the load to supply the current required by the load; and
(d5) when the battery capacity of the rechargeable battery is lower than the second predetermined value, keeping conducting the charging operation from the power supply apparatus to the rechargeable battery.

3. The control method for supplying power of claim 2, wherein the second predetermined value is greater than the first predetermined value.

4. The control method for supplying power of claim 3, wherein the first predetermined value is represented by a State of Charge (SOC) or a voltage level and the second predetermined value is represented by a State of Charge (SOC) or a voltage level.

5. A power bank, comprising:
a rechargeable battery;
a charging switch for controlling a charging path to the rechargeable battery;
a discharging switch for controlling a discharging path from the rechargeable battery; and
a control circuit for controlling the charging switch and the discharging switch according to current information of the charging path, current information of the discharging path, and battery capacity information of the rechargeable battery.

6. The power bank of claim 5, wherein the charging path is coupled between the rechargeable battery and a power supply apparatus, and the discharging path is coupled between the rechargeable battery and a load; and wherein:
when a supply current from the power supply apparatus is higher than a current required by the load, the control circuit turns ON the charging switch and the discharging switch.

7. The power bank of claim 5, wherein the charging path is coupled between the rechargeable battery and a power supply apparatus, and the discharging path is coupled between the rechargeable battery and a load; and wherein:
when a supply current from the power supply apparatus is lower than a current required by the load and when a battery capacity of the rechargeable battery is higher than a first predetermined value, the control circuit turns ON the discharging switch.

8. The power bank of claim 5, wherein the charging path is coupled between the rechargeable battery and a power supply apparatus, and the discharging path is coupled between the rechargeable battery and a load; and wherein:
when a supply current from the power supply apparatus is lower than a current required by the load and when a battery capacity of the rechargeable battery is lower than a first predetermined value, the control circuit turns ON the charging switch and turns OFF the discharging switch.

9. The power bank of claim 8, wherein after a predetermined period of time subsequent to turning OFF the discharging switch by the control circuit, the control circuit turns ON the discharging switch when the battery capacity of the rechargeable battery is higher than a second predetermined value.

10. The power bank of claim 8, wherein after a predetermined period of time subsequent to turning OFF the discharging switch by the control circuit, the control circuit keeps turning ON the charging switch and keeps turning OFF the discharging switch when the battery capacity of the rechargeable battery is lower than a second predetermined value.
